(19) United States
(12) Patent Application Publication
(10) Pub. No.: US 2003/0086186 A1
(43) Pub. Date: May 8, 2003

(54) Door mirror viewer

(76) Inventor: Khosrow Bahrayni-Moghaddam, Weston (CA)

Correspondence Address: Khosrow Bahrayni-Moghaddam, 36 Arkley Crescent, Weston, ON, M9R 3S3, CA

(21) Appl. No.: 10/102,639

(22) Filed: Mar. 22, 2002

Related U.S. Application Data
(63) Continuation-in-part of application No. 10/042,432, filed on Jan. 10, 2002.

(30) Foreign Application Priority Data
Oct. 30, 2001 (CA) 2360512

(51) Int. Cl. G02B 5/08

(52) U.S. Cl. 359/838

(57) ABSTRACT

The present invention provides a security system for use in a door to enable a person on the inside of the door to view anyone on the outside of the door. The system has a lens system connected to an electronic mirror located on the inside of the door. The electronic mirror is preferably a flat-panel display system. In a preferred embodiment, the system provides a prefabricated unit which can be door-mounted through a small hole through the door. The unit allows the person on the inside of the door to view activity on the outside of the door from a distance. An improved security system is provided.

This is a continuation in part of U.S. patent application Ser. No. 10/042432 filed Jan. 10, 2002.

### BACKGROUND OF THE INVENTION

1. Field of the Invention

The present invention relates to a door viewer security system, and in particular, to a door-mounted camera and viewer.

2. Description of the Prior Art

Door-mounted “peep-hole” viewers are commonly available and used as a security feature. These devices commonly have a lens at one end of a 1 to 3 cm diameter tube which tube passes through an entry door. A person on one side of the door can look through the viewer and observe persons and/or activity on the other side of the door. With this information, the person can decide whether to open the door or not.

One problem with these types of door viewers is that the image is very small and the person must stand directly beside the door in order to observe who or what is at the door. As such, the person must approach the door and can be sometimes heard or seen by the person outside of the door.

Further, the door viewer may be mounted at a height where smaller people, and in particular, children, may not be able to use the door viewer, and thus they cannot see the person on the other side of the door. As such, they commonly merely open the door and thus defeat the purpose of the door viewer.

Prior art systems are also known which use a larger, optical door viewer that provides a larger image. However, these systems require that a large hole be drilled through the door, and still only provide an image which is 2 to 6 cm in width.

A further problem with existing optical door viewers is that it is possible for those outside the door to use an optical attachment over the lens of the door viewer which allows those outside the door to observe what is occurring inside. Thus, a potential burglar or the like, can use the door viewer to observe whether anyone is inside.

Prior art systems are also known which involve the use of various cameras which are mounted on, or adjacent to the entry door. However, these devices are commonly used to provide video signals which are displayed on a television or other remote monitoring devices. Further, with door-mounted cameras, the user must arrange for a wiring system (or wireless system) to transfer the video signal to the remote monitoring device. Further, these systems require some power transfer to the camera, and thus, connection to a power source is required.

### SUMMARY OF THE INVENTION

In accordance with one aspect of the present invention, there is provided a door-mounted Mirror Viewer adapted to be installed on a door having an outside surface and an inside surface, comprising a lens for viewing the area outside of the door, and an electronic mirror located on the inside of the door, for viewing the image captured by the lens. The lens is preferably part of a small camera, and the electronic mirror, or more generally, the display, is preferably a small flat-screen monitor of the type currently found on digital cameras, or hand-held video cameras. Suitable displays would include screens including Liquid Crystal Displays (LCD's), plasma display units, or the like. The door mirror viewer system is preferably contained primarily in a housing which would be located on the inside of the door, and would be powered by a battery contained within the housing.

The Mirror Viewer of the present invention is particularly suited for use on the entry door of an apartment or house, but other applications could easily be identified.

The lens system, comprising a lens and a tube, would extend from the housing, through the door to the outside of the door. Preferably, the lens system would use a 1 to 3 cm diameter tube, and thus, would be suitable for fitting into the hole made for traditional, prior art, optical door viewers. Because of the small opening through the door, there is little need for additional insulation to be added to the door, or this easily accomplished due to the small size of the opening through the door.

The image provided by the electronic mirror would preferably be large enough to be clearly seen at a distance of at least 2 meters, and more preferably, clearly seen at a distance of 5 meters. As such, the person on the inside of the door would not need to approach any closer than 2, or preferably 5 meters from the door in order to determine whether it was safe to open the door, or whether it was necessary to call for assistance.

A preferred size for the electronic mirror would be at least approximately 20 cm by 20 cm, although this size could be easily changed.

The door mirror viewer can be adapted to include known systems for determining activity on the outside of the door, through the use of motion detectors, for example, in order to automatically turn on and show the image of the person or activity on the outside of the door, on the electronic mirror display, for a set period of time after activity has ceased on the outside of the door.

Advantages of the system of the present invention include that the image can be seen at a distance from the door, by people of all heights, including small children, and that little additional damage is done to the door to install the door mirror viewer over prior art, traditional door viewers. Further, since the housing contains the battery and electronic mirror, there is no need to provide wiring or power to a movable door. Also, since the electronic mirror is mounted on the door, there is no need to start up an external viewing device, such as a television set.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention.

Embodiments of this invention will now be described by way of example in association with the accompanying drawings in which:

FIG. 1 is a front view of a door mirror viewer of the present invention;

FIG. 2 is a perspective view of the door mirror viewer of FIG. 1;

FIG. 3 is a side view of the door mirror viewer of FIG. 2;

FIG. 4 is a front, plan view of a rubber washer used for mounting of the door mirror viewer of FIG. 1;

FIG. 5 is a plan view of a wood screw used for mounting of the door mirror viewer of FIG. 1;

FIG. 6 is a perspective view of the door mirror viewer of the present invention shown in use;

FIG. 7 is a side view of the door mirror viewer of the present invention mounted in a door:

FIG. 8 is a representation of an image to be observed through the door mirror viewer;

FIG. 9 is a representation of the image of FIG. 8 shown on the door mirror viewer;

FIG. 10 is a further image to be observed; and

FIG. 11 is a representation of a hand-held camera utilizing some of the same technology as that of the present invention.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

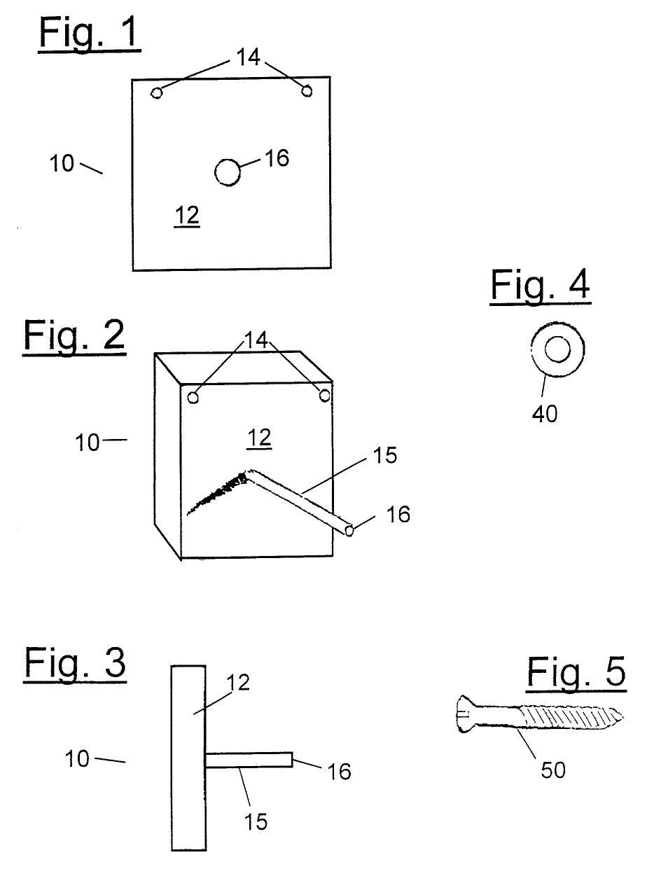

FIG. 1 shows a front view of a door mirror viewer 10 of the present invention. Door mirror viewer 10 has a housing 12 which is 20 cm square, and has two screw holes 14 for mounting with wood screws 50; which are shown in FIG. 5. Rubber washers 40, shown in FIG. 4, are used between the housing 12 and a door, when mounted. A lens 16 is shown connected to the centre of housing 12, although the exact location of lens 16 might be changed.

In FIG. 2, the lens 16 is best seen, and is mounted at the end of tube 15. Tube 15 extends 5 cm from the back surface of housing 12. The electronic mirror (not shown) would be located on the front surface of housing 12. The lens 16 and tube 15 have a diameter of 2.5 cm and, thus, this lens and tube assembly is adapted to extend through a 2.5 cm hole drilled through a door. As such, lens 16 is located at the outer surface of the door, housing 12 remains on the inside of the door, and the image from lens 16 passes through tube 15 to housing 12.

In FIG. 3, a side view of door mirror viewer 10 is shown wherein lens 16 and tube 15 are shown extending away from housing 12. Housing 12 has a width of approximately 2 cm, and thus, does not protrude excessively from the door.

A distinct advantage of the arrangement shown in FIGS. 1 to 3, is that the door mirror viewer can be prefabricated as a unit and is ready for immediate installation. There is no need for additional wiring to be provided since the prefabricated unit is preferably powered by a battery located within the housing.

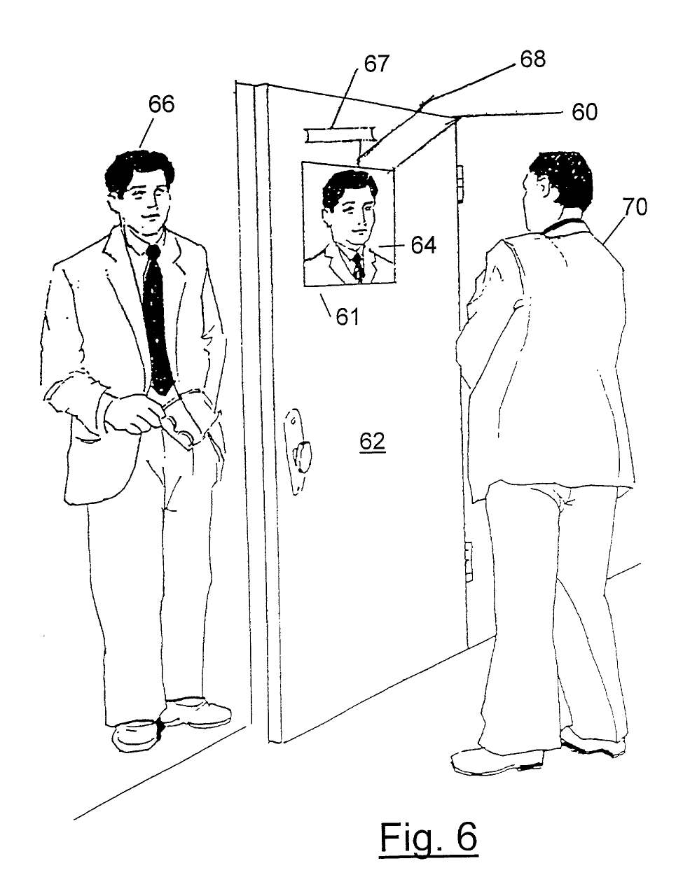

FIG. 6 shows a view of another embodiment of the present invention where door mirror viewer of the present invention is shown in use. Electronic mirror 60 is mounted on the inside of door 62. The image 64 of a person 66 on the outside of door 62 is shown on electronic mirror 60. In this variation, the camera and lens assembly 67 are mounted through door 62 and are not part of the housing 61 for electronic mirror 60. Wires 68 are provided for transferring the signal from the camera and lens assembly 67 to the electronic mirror 60.

The person 70 on the inside of door 62 can clearly see image 64, and can thus decide from a distance, whether to open door 62 or not.

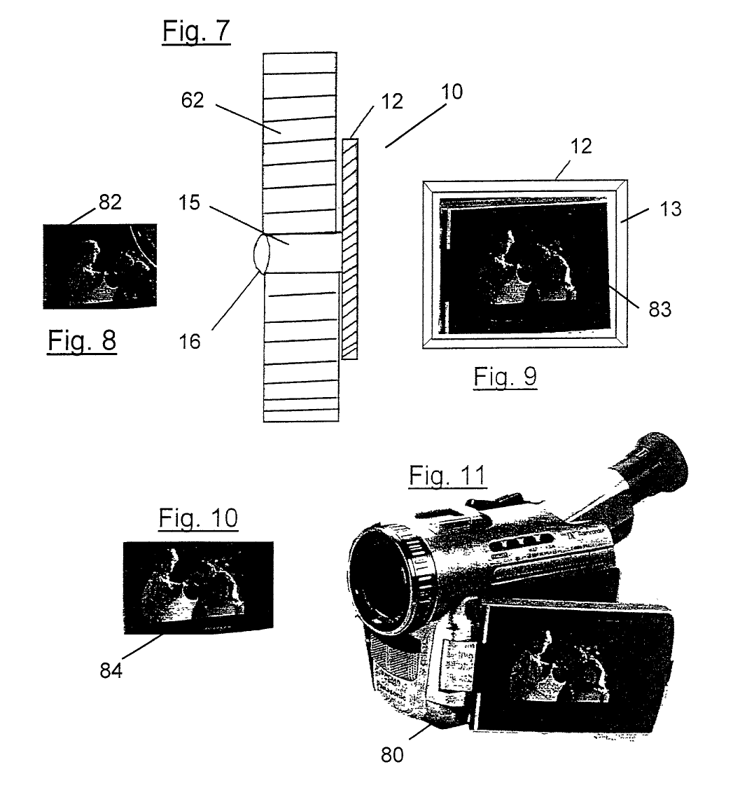

In FIG. 7, a cross-sectional side view of the door mirror viewer 10 of FIG. 1 is shown passing through door 62. Lens 16 is located on the outer surface of the door and is connected to tube 15. The image 82, seen in FIG. 8, passes through lens 16 and through tube 15 to housing 12 where it is processed and appears as an image 83, in FIG. 9, on the electronic mirror 13 contained within housing 12.

A further image 84 is shown in FIG. 10, which can be viewed in, for example the display system of a commonly available video camera 80, shown in FIG. 11. It can clearly be seen how the technology from this type of camera 80 can be adapted for use in the door mirror viewer of the present invention.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially planar is intended to mean planar, nearly planar and/or exhibiting characteristics associated with a planar element.

What is claimed is:

1. A door-mounted Mirror Viewer adapted to be installed on a door having an outside surface and an inside surface, comprising a lens for viewing the area outside of the door, and an electronic mirror located on the inside of the door, for viewing the image captured through the lens.

2. A door-mounted mirror viewer as claimed in claim 1 wherein said lens comprises part of a camera.

3. A door-mounted mirror viewer as claimed in claim 1 wherein said electronic mirror is a flat-screen monitor.

4. A door-mounted mirror viewer as claimed in claim 3 wherein said flat-screen monitor is a Liquid Crystal Displays (LCD's) or a plasma display unit.

5. A door-mounted mirror viewer as claimed in claim 1 wherein said electronic mirror has a size of at least 20 cm by 20 cm.

6. A door-mounted mirror viewer as claimed in claim 1 wherein said lens and said electronic mirror are housed within a prefabricated unit comprising a housing adapted to be mounted on one side of a door, a lens section comprising a lens mounted on an opposite side of a door, and a tube section which extends through said door.

7. A door-mounted mirror viewer as claimed in claim 6 wherein said lens section comprises a tube having a diameter of from 1 to 3 cm.

8. A door-mounted mirror viewer as claimed in claim 1 wherein said viewer is powered by battery power.
